(19) United States
(12) Patent Application Publication
(10) Pub. No.: US 2009/0222851 A1
(43) Pub. Date: Sep. 3, 2009

(54) METHOD, DEVICE AND COMPUTER PROGRAM PRODUCT FOR DISPLAYING AN ADVERTISEMENT TO A USER

(76) Inventor: Shahar Talmi, Tel Aviv (IL)

Correspondence Address: Pearl Cohen Zedek Latzer, LLP, 1500 Broadway, 12th Floor, New York, NY, 10036, US

(21) Appl. No.: 12/395,725

(22) Filed: Mar. 2, 2009

Related U.S. Application Data
(60) Provisional application No. 61/032,975, filed on Mar. 2, 2008.

(51) Int. Cl. H04N 7/025; H04N 7/173

(52) U.S. Cl. 725/32; 725/119; 725/131

(57) ABSTRACT

A method for displaying advertisement to a user, the method includes: receiving, over an out of band channel and by an advertisement fulfillment engine that utilizes interactive capabilities of a user device, information representative of a first thin advertisement; determining, by the advertisement fulfillment engine, to display the first thin advertisement on a display that is coupled to the user device; instructing the display, in response to the information and to the determination, to display the first thin advertisement; and displaying the first thin advertisement in addition to a display of a video asset that is provided by a non-linear video infrastructure.

### CROSS REFERENCE TO RELATED APPLICATIONS

This application claims the benefit of U.S. Provisional Patent Application No. 61/032,975, filed on Mar. 2, 2008, which is incorporated in its entirety herein by reference.

### BACKGROUND OF THE INVENTION

TV viewing habits are changing rapidly, mainly due to “Non-Linear TV viewing”, where each user decides what, and more importantly—when to consume TV content. The most popular Non-Linear TV technology is called Video on Demand (VOD). In a VOD service, a massive amount of content is stored in the TV Provider network. Each user can select the desired content usually without replacing any customer premise equipment. Another Non-Linear technology is the Personal Video Recorder or PVR. PVR is basically a Set-Top-Box (STB) with additional, recordable storage space. Each user may record content and view it at any designated time. Additional technologies under the term “Non-Linear TV” rely on one or both of the above technologies and propose similar user experience, such as Push VOD (the ability to push content to a PVR), catch up TV (the ability to go back at a click of a button to the beginning of a media asset, NPVR (Network based Personal Video Recorder the ability to record media assets and to store them on the network), TSTV (Time Shift TV the ability to record several media assets i.e. the last three days and to let the user to navigate backwards in time) and others (referred as NLTA Non Linear TV Applications).

While different technologies used for Non-Linear TV technologies require different resources from the TV Provider and the user, they have one thing in common: The viewing experience is superior to traditional TV viewing. Non-Linear technologies are already out of the ‘early adopters’ stages and well into the ‘mass market’ stages in markets like North America, Europe and parts of Asia.

A side effect of Non-Linear TV is that users have a new method of skipping thin advertisements (commercials): they can simply press the fast forward button in the remote control. IBM recently issued a report where it claims that in 2007, PVR users in the US alone caused the US TV Advertising Industry revenue loss of approximately $4 bn (The overall TV advertising industry in the US is ˜$70 bn).

Ad skipping effect on VOD usage is even more severe. Inserting thin advertisements into VOD streams requires the TV Providers for significant CAPEX and OPEX investments. However, even when such investments are made, users tend to skip thin advertisements all together. Therefore, the ROI for such insertion projects is questionable.

With the evolvement of Digital Television (DTV), operators upgraded their networks to gain the capability of having return channel, which enables two-way communication with the set-top boxes located at the subscriber's household. The return channel enabled operators to provide interactive TV applications such as messaging, enhanced TV, games, etc.

Currently there are three different techniques to deliver content to DTV subscribers—broadcasting, out of band (OOB) return channel and IPTV.

Broadcasting includes broadcasting information such as can include data, video and audio content. The information is carried on HFC in the case of CATV or satellite in the case of DBS. In all cases the communication is half duplex. That means that information can be sent to the TV subscriber's set-top boxes but cannot be received from them. This method is called In Band channel broadcasting and it is used for broadcasting programs, video channels, audio channels and data download of applications to the set-top boxes. Information that is sent through the in band is broadcasted to all subscribers.

Out Of Band return channel communication that depends on the architecture of the network being used to carry the information. In DBS operators, the set-top boxes are equipped with modem that enables a point-to-point communication. In this manner information can be sent and received by the modem. This of course demands client software that will handle the communication and will run of the set-top box. In the case of CATV (Community Antenna Television) operators the situation is much better due to the use of cable modems such as DOCSIS and DVB-RC that provide more bandwidth to send and receive information to the set-top box.

IPTV (Internet Protocol Television) enables unicasting of video content to TV subscribers using xDSL or Fiber as a broadband communication channel. •The use of IPTV requires different architecture both for the operator and the subscriber as well (new set-top box).

One of the emerging killer applications that uses both the return channel and the in-band channel and has a unique architecture is VOD. In this unique application the video which is non linear is transmitted using special video server that broadcast the content to a group of households (in a multicast manner in case of CATV or unicast in case of IPTV) and enables the TV subscribers to enjoy a wide range of video content based on their demand.

The successful adaptation of NLTA services has raised the need to provide adaptive advertisement & promotions in the content in a different manner than broadcast.

### SUMMARY OF THE INVENTION

The successful adaptation of NLTA services has raised the need to provide adaptive advertisement & promotions in the content in a different manner than broadcast.

A method for displaying advertisement to a user, the method includes: receiving, over an out of band channel and by an advertisement fulfillment engine that utilizes interactive capabilities of a user device, information representative of a first thin advertisement; determining, by the advertisement fulfillment engine, to display the first thin advertisement on a display that is coupled to the user device; instructing the display, in response to the information and to the determination, to display the first thin advertisement; and displaying the first thin advertisement in addition to a display of a video asset that is provided by a non-linear video infrastructure.

A method for displaying advertisement to a user, the method includes: receiving over an out of band channel and from a an advertisement fulfillment engine that utilizes interactive capabilities of a user device, a request to obtain information representative of a thin advertisement; wherein the thin advertisement is to be displayed on a screen in parallel to a display of a video asset that is provided by a non-linear infrastructure; selecting, by an advertisement server, at least one selected thin advertisement in response to user device interactivity limitation, and user information; generating information representative to the selected thin advertisement; and sending the information to the user device.

A user device comprising at least one interface and an interactive module; wherein the interactive module supports an advertisement fulfillment engine that determines to display a first thin advertisement on a display; and wherein the at least one interface receives over an out of band channel information representative of a first thin advertisement; wherein the display receives instructions to display the first thin advertisement in addition to a display of a video asset that is provided by a non-linear video infrastructure.

A computer program product that comprises a computer readable medium that stores instructions that when executed by an interactive module of a user device causes the interactive module to: receive over an out of band channel, by an advertisement fulfillment engine that is executed by the interactive module, information representative of a first thin advertisement; determine, by the advertisement fulfillment engine, to display the first thin advertisement on a display; and instruct the display, in response to the information and to the determination, to display the first thin advertisement; wherein the first thin advertisement is displayed on the display in addition to a display of a video asset that is provided by a non-linear video infrastructure.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system, according to an embodiment of the invention;

FIG. 2 illustrates a system, according to another embodiment of the invention;

FIG. 3 illustrates a set top box according to an embodiment of the invention;

FIG. 4 illustrates a set top box according to an embodiment of the invention;

FIG. 5 illustrates a client that includes a advertisement fulfillment engine according to an embodiment of the invention;

FIGS. 6 and 7 illustrate methods for displaying advertisement to a user, according to two embodiments of the invention; and

FIG. 8 illustrates a system, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to an embodiment a client is provided. The client includes an advertisement fulfillment engine that utilize interactive capabilities of a set to box. The client facilitates a display of thin advertisements while using existing resources of set top boxes and even low end set top boxes that have limited computational resources and/or memory resources Conveniently, the client can installed without changing the set top box and without any time consuming configuration process. The client is adapted to interface with the middleware of the set top box via interfaces such as APIs and the like.

Thin advertisements can be displayed on a display of a user device or on a display that is connected to the user device. The user device can be a mobile phone, a laptop computer, a media player, a personal data accessory or a set top box. For simplicity of explanation the following description relates to a set top box.

The set top box has an interactive module that has memory resources and computational resources. These resources can part of a processor (that executed other tasks) and of a memory bank (that can also be used for other purposes) but can have its dedicated memory unit and processor.

The term “thin advertisements” is an advertisement and or a promotion message that does not require extensive memory and/or computational resources for being displayed. The size of the thin advertisement and, additionally or alternatively a computational load associated with its display can be tailored according to the capabilities of the set top box.

Usually, thin advertisements that are sent to low end set top boxes do not include video but rather graphics, and additionally or alternatively audio content. The term “thin advertisement” also includes any type of information representative of the thin advertisement—information that can be processed by a set top box to provide an advertisement.

The thin advertisement can advertise a content, TV provider service, a product or a service, can solicit the user to perform an act such as obtaining more information regarding a promoted service or product, ordering such a promoted item, and the like. The user can react to such a promotion message by utilizing the OOB channel, the in band channel but this is not necessarily so.

The term “user device” is a device that can be owner by a user, viewed by a user or connected to a display that can be viewed by a user. A user device can reside in an office, in the user's premises, and the like. A user device can be, for example, a set top box, a media player, a mobile device, a entertainment center, and the like.

The term user can include a person that owns a user device, a person that utilizes the user device, a person that views a thin advertisement and the like.

Non-limiting examples of thin advertisements can include:

i. A static or dynamic thin advertisements that require no response from the user;
ii. A thin advertisement that solicit the user to click or otherwise perform an interactive operation in order to retrieve more information (via set top box, mail, phone, Internet);
iii. A thin advertisement that facilitates a purchase of a product or service, a thin advertisement that solicits the user to schedule an event related to the video provider or operator (for example—recording of a video asset, user care activity);
iv. A thin advertisement that solicits the user to perform an action (such as press an esc button) that will change the manner in which the thin advertisement is viewed and even stop the display of the thin advertisement;
v. A thin advertisement that solicits the user to sign up for related thin advertisement s;
vi. A thin advertisement that asks a user a question or provides the user with a quiz.
vii. Stopping a thin advertisement from being pressing i.e. enabling esc'
viii. Animated thin advertisement

Non-limiting examples of manners in which a thin client is displayed Include:

i. Banner—the thin advertisement is bounded to an image that is located in an area that appears on the display.
ii. Display over an area while the video assess display area shrinks
iii. Icon (such as button)—that once interacted with can trigger various events such as display of information, stopping the display of the thin advertisement and the like.
iv. Slide presenting before or after media asset. Slide may pause the content while displaying
v. Playing audio and audio manipulation

Once thin advertisements (or information representing thereof) are stored at the set top box the advertisement fulfillment engine can determine when to display them. The display of thin advertisements can be triggered by various events including events relating to non-linear viewing of a video asset, time based events and miscellaneous predefined events such as before receiving an VOD video asset, after the end of the video asset, a trick play event, an info query by the user, a time period after the last pause request was received, a predetermined sequence of trick play commands, a change of scene, a request to change a volume of the video asset or a request to change a channel, to change a display parameter (such as brightness, color) and the like.

The client can be downloaded to the set top box in various manners including but not limited to downloading by using an interactive carousel or other time division multiple technique, using an out of band channel or in band channel and the like.

The client can be activated in various manners including but not limited to activation by a VOD server (or VOD service entity) or VOD client any other NLTA client activation by set top box, activation in response to a video asset that is being processed to be displayed by the STB. The client can always run, can perform time sharing of resources with other clients or resource consumers of the set top box, can be activated in predefined time windows, and the like.

The client can communicate with an advertisement server, can request to receive information representative of one or more thin advertisements, can select which thin advertisements to display (out of multiple thin advertisements currently stored at the set top box), can ask the advertisement server to select which thin advertisement to display, can manage the retrieval and deletion of thin advertisements, can cause the set top box to instruct the display to display a thin advertisement, can react to trick play commands (or trick play events), can interact with a middleware of the set top box, can interact with or be integrated within another client (such as a NLTA client), can request or otherwise obtain information relating to the set top box, to video assets viewed by a user, to the user, to user viewing patterns and the like. The client can apply one or more predefined rules for managing thin clients.

The client can communicate with an advertisement server, conveniently over an out of band channel. The advertisement server can determine which thin advertisements to send to the client, can obtain information (during a so-called enrichment process) relating to the set top box or clients from the client or from other sources from within the TV operator by querying systems like billing and customer care and outside the TV provider domain such as credit card information, can determine (or select between different candidates) the format of a thin advertisement, a size of a thin advertisement, and the like.

The client, the advertisement server or both can manage the flow of thin advertisements to the set top box. For example, one or more new thin advertisement can be sent to the set top box in response to the available memory resources, yet for another example, one or more stored thin advertisements can be deleted form the set top box when the user changes a channel.

Each of the client and the advertisement server can make decisions in real time, in near real time or in off line.

The client can be downloaded by using an interactive carousel or other time division multiple techniques, using an out of band channel or in band channel and the like.

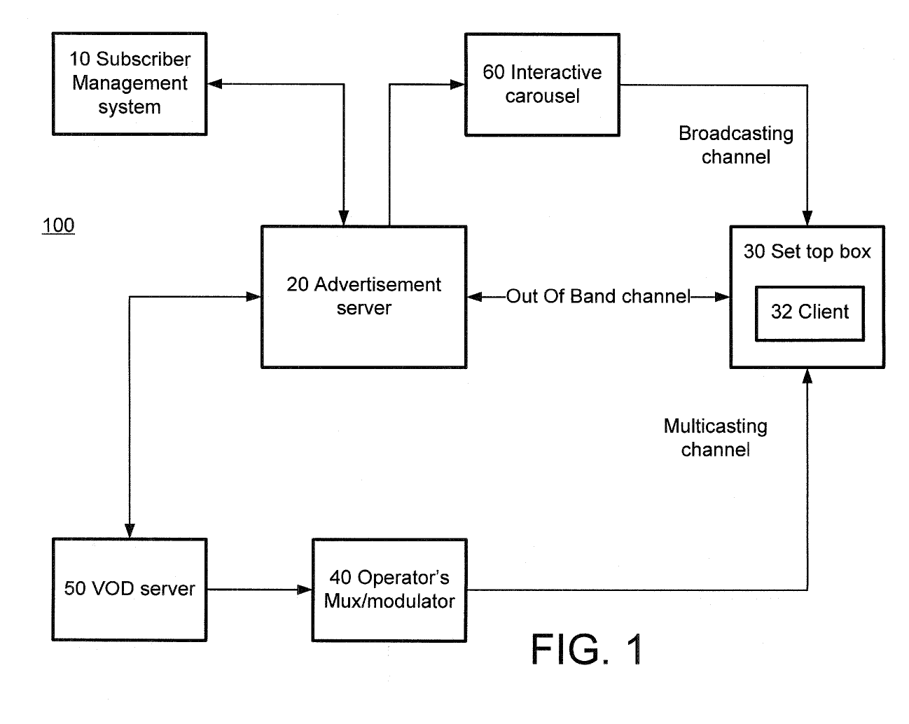

FIG. 1 illustrates system 100, according to an embodiment of the invention. System 100 includes some or all of the following components: subscriber's management system 10, advertisements server 20, operator multiplexer and/or modulator 40, VOD server 50, and interactive carousel 60. It is noted that system 100 is configured to provide multimedia content (e.g. picture, sound, video, animation, text, etc., and, according to several embodiments of the invention, especially advertising content, and especially a thin advertisement content, which has low size requirements) to one or more set top boxes such as set top box 30, or to other end user equipment. It is noted that set top box 30 is usually configured for reception of multimedia data (and especially television content) distributed by a distribution system (e.g. such as a cable TV headend), wherein system 100 may be included within the distribution headend, may be connected thereto, and may be separate thereof (in which case it may and may not exchange information with the distribution system).

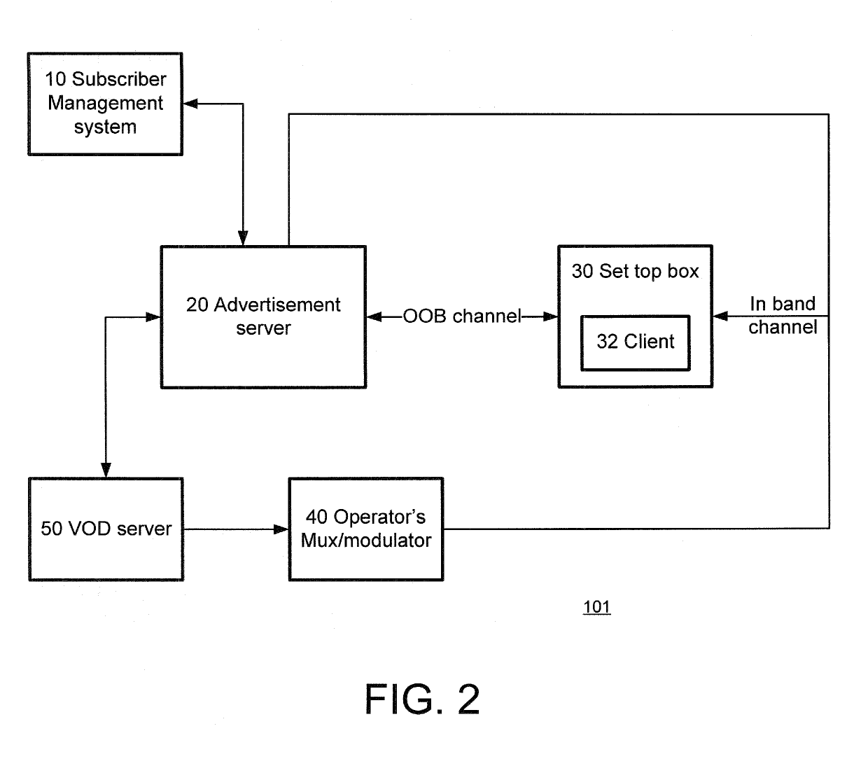

FIG. 2 illustrates system 101 that does not have a interactive carousel and in which the broadcasting channel and the multicasting channel are merged to form an in band channel.

According to an embodiment of the invention, system 100 may be used by a multimedia operator (also referred to as TV operator) that have an out of band return channel (denoted “return channel”) to enjoy and to gain the capability of providing wide range of multimedia content such as thin advertisement and promotions types (i.e. video, text, banners, still pictures, animations and audio) using the out of band channel on a NLTA. Examples for such operator types are—CATV, IPTV (using DSL or any broadband return channel) and satellite operators deploying PVRs with return channels.

The OOB channel can include a return path (also referred to as OOB upstream path) and an OOB downstream path.

According to an embodiment of the invention, advertisement server 20 is a dedicated server, but it may also have other functionalities, such as standard distribution server functionalities. Advertisement server 20 conveniently communicates with client 32 which reside in the set-top box 30 and provides a wide range of multimedia content (also referred to as thin advertisement s and/or promotions), such as: Video, Text, Audio, Still pictures, Animation or a combination thereof.

Client 32 of set top box 30 can conveniently run on COTS compliant set top box such as, for example, existing legacy low-end set-top boxes, with no need to replace/change installed hardware or software at the operators premises. Advanced set-top boxes with more CPU power, Memory capacity, or PVR capability are supported as well. Such advanced set top boxes can execute thicker advertisements.

For example, system 100 may add interactivity to thin advertisement which are sent to the set-top boxes through the OOB return channel. It is noted that, according to an embodiment of the invention, the multimedia content provided by system 100 is an interactive content. According to such an embodiment of the invention, the TV subscriber will have the capability to respond to each thin advertisement interactively (e.g. requesting additional information, requesting to be contacted by a sales representative, and so forth).

According to an embodiment of the invention, all the above capabilities will be enabled on the existing wide range of legacy, low end set-top boxes 30 which are equipped with an OOB return channel, with no need of special change to the existing hardware or software configuration. New set-top boxes can also receive the client without further modifications.

According to an embodiment of the invention, system 100 may utilize the out of band communication channel for providing targeted and personalized multimedia content (e.g. thin advertisement), e.g. based on demographic parameters retrieved from the operators database.

According to an embodiment of the invention, system 100 (and especially, according to an embodiment of the invention, advertisement server 20 is configured to receive from STB 30 an indication relating to a trick play selection (e.g. special keys such as—pause, rewind and fast forward) made by a user of STB 30, and to respond to the indication with provisioning of content to the STB 30. Yet for another embodiment the client 32 responds to the trick play selection and not advertisement server 20. Advertisement server 20 can be notified of the selection—in near real time or off line.

It is noted that, according to an embodiment of the invention, system 100 may respond similarly to other user activity (or inactivity) indication, e.g. when changing a channel, when changing volume, requesting information etc. It should be noted that the user is assumed to have more attention to a display that is connected to the STB 30, when performing a viewing-related activity.

A thin advertisement can be triggered, according to an embodiment of the invention, by the subscriber (also referred to as user) when he uses trick-play (special keys—e.g. pause, rewind and fast forward) during the regular content viewing session or by the advertiser who can embed thin advertisement during the video session.

Conveniently, system 100 facilitate providing of content (such as thin advertisement) on non linear video any NLTA using existing installed based of set-top boxes, and their future set-top boxes, without the need to invest a large effort and money in upgrading to ad-insertion capabilities. According to an embodiment of the invention, system 100 enables the end user with a better way to watch thin advertisements suited to the non linear experience of viewing video of any NLTA.

It is noted that conveniently, system 100 (and especially, according to an embodiment of the invention, advertisement server 20) is configured to provide the multimedia content (e.g. thin advertisement) in a non-linear mode (e.g. during a VOD session) without using standard video ad-insertion equipment, and without cutting the stream of video. For example, the multimedia content may be provided by the STB 30 above or below the stream of video (e.g. in a subtitle area of a VOD movie that is watched by the user).

It is noted that conveniently, the advertising multimedia content is not provided using the broadcasting channel. Interactive carousel 60 can be used for downloading client 32 to STB 30 or to send thin advertisements to client 32. Interactive carousel 60 can be broadcast or otherwise transmitted over a dedicated program or frequency.

It is noted that trick-play is usually being used only in cases of broadcasting using a pre-installed client on STB 30 and return channel.

It is noted that system 100 may include one or more processing units, in one or more of the modules. Also, it is noted that a module that is herein described as a single module may be implemented as several modules (which may and may not be interconnected), and that a single implemented module may incorporate functionalities of more than one described module.

According to an embodiment of the invention, advertisement server 20 can have advertisement management capabilities or can be connected to a campaign manager (not shown). Yet according to another embodiment of the invention advertisement server 20 can have advertisement decision capabilities of can be connected to an advertisement decider (not shown).

Campaign management can include: (i) building thin advertisements (defining and verifying the user interface, timeline and interactivity for each thin advertisement), (ii) converting various media types into set top box ready media type (iii) verifying that each media performs as expected in a set top box environment. (iv) encrypting in any COTS method advertisements so that a third party software may count them. (v) defining campaigns (creating, editing campaigns and associating thin advertisements and rules to them), (vi) thin advertisement selection (selecting the most relevant thin advertisement ad at a given time while enforcing campaign rules), (vii) thin advertisement event handling (receiving events for thin advertisements serving and interaction and storing them), or (viii) monitoring campaigns (monitoring statistics and generating manual and automatic reports).

Advertisement decision capabilities can include: (i) placement—receiving thin advertisement placement requests from set top boxes, enriching request data, querying the campaign manager and returning placement response to the STB, (ii) Advertisement notification—receiving thin advertisement notifications from STB indicative that a thin advertisement was displayed and forwarding them to the campaign manager, (iii) selection of thin advertisements that can be sent to a STB, (iv) obtaining information that can assist in selecting thin advertisements to be sent to a certain STB.

A thin advertisement can be selected based on information from multiple data sources, such as user behavioral history, content attributes, calendar, campaign rules, campaign budget and pricing and etc. The selection can also be responsive to user information, user viewing patterns, thin advertisements that were displayed or ignored of, and the like.

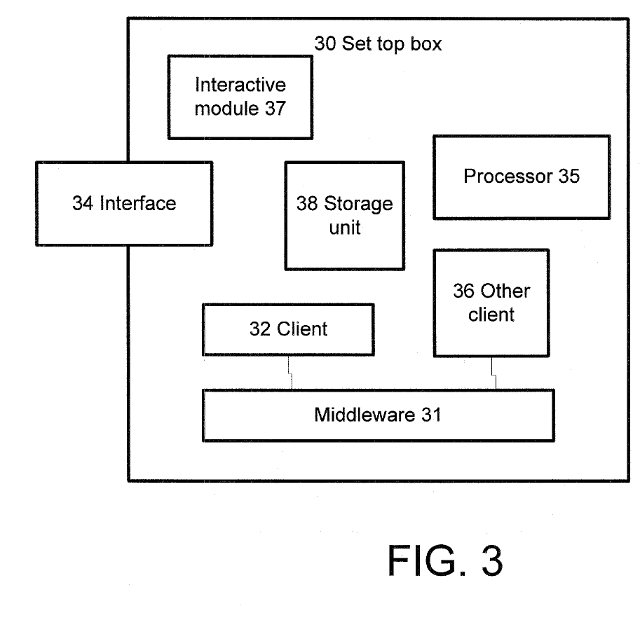

FIG. 3 illustrates STB 30, according to an embodiment of the invention. FIG. 3 illustrates both hardware components, software components and a middleware component. For example, processor 35 can execute middleware 31, other client 36 and client 32. Interactive module 37 can have its own storage and computational resources but can utilize at least some of the computational resources of processor 35 and additionally or alternatively use at least one storage resource of storage unit 38.

STB 30 includes hardware components such as (a) interface 34 for receiving information from OOB channel, in band channel or a combination thereof, and (ii) processor 35 for executing middleware 31, client 32 and another client 36. Other client 36 can be a VOD client, a PVR client or a combination thereof.

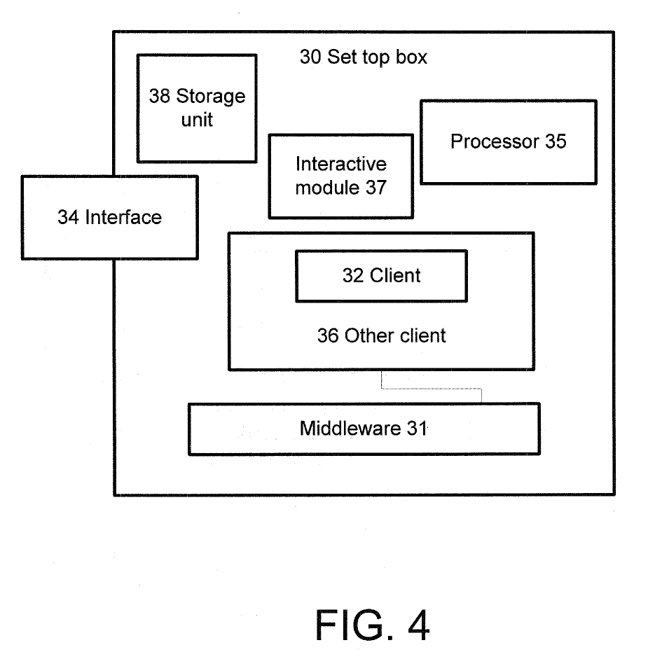

Client 32 can be embedded within other client 36—as illustrated in FIG. 4 or not be integrated (as illustrated in FIG. 3).

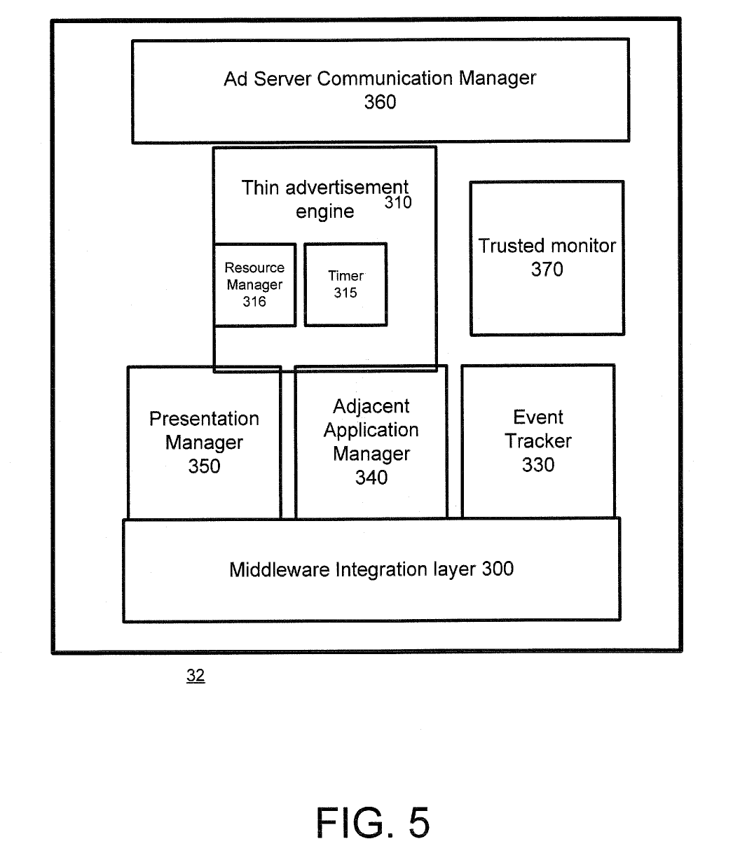

FIG. 5 illustrates client 32 according to an embodiment of the invention. Client 32 includes (i) middleware integration layer 300, (ii) thin advertisement engine 310 that includes timer 315 and resource manager 316, (iii) event tracker 330, (iv) adjacent application manager 340, (v) presentation manager 350, and (vi) advertisement server communication module 360.

Middleware integration layer 300 is a software layer designed to work with middleware 31 of STB 30. Middleware integration layer 300 can be agnostic to the actual STB hardware and can run in any middleware environment once interoperability testing occurs.

Thin advertisement engine 310 controls client 32. Information relating to thin advertisements, events, triggers, viewed video assets, user information and the like can be provided to it. It can perform advertisement management, and can hold the logic of what thin advertisement to present at any given time. Thin advertisement engine 310 can also control the communication with advertising server 20 via the advertisement server communication manager 360.

Timer 315 is included in thin advertisement engine 310 and is responsible to measure time from various events. For example it can measure the time from the beginning of the media asset and allow the thin advertisement engine to present a thin advertisement after 10 minutes. Another example may be to present a thin advertisement 5 seconds after a trick play activity was over.

Resource manager 316 can be included in thin advertisement engine 310. Traditional interactive applications assume certain resources from the set-top-box, while the thin advertisement engine should manage the set-top-box resources in order to optimize network and memory usage. Traditional interactive applications are stateless, while thin advertisement engine 310 stores its state and cookies in the set-top-box persistent storage. Resource manager 316 of thin advertisement engine 310 can manage this task.

In order to achieve that purpose a resource manager 316 can be provided. It can be constantly aware of the memory and network usage on STB 30 and will manage the communication with an advertisement server while buffering information in a virtual file system on STB 30.

Event tracker 330 can notify thin advertisement engine 310 on trick play events and can notify middleware integration layer 300 in the event that a trick play bar should be modified or not shown at all.

Adjunct application manager 340 can manage the communication with other client 36.

Presentation manager 350 can be in charge on presenting thin advertisements outputted by thin advertisement engine 310.

Communication manager 360 is in charge of the communication with the advertisement server 20. In the event that third party verification software is used the Communication manager 360 will communicate with such third party headed server. In the event that the OOB return channel is a dialup channel then communication manager 360 can manage the dialup process as well.

FIG. 5 also illustrates trusted monitor 370. Trusted monitor 370 can be used, for example, in the advertising business—to monitor after activities related to advertisements. In the broadcasting domain such information could be obtained from companies like The Nielsen Company and or TNS. The measurement method used in the broadcasting domain is a statist sampling. In the non linear domain statist sampling do not make sense as every user is different. The trusted monitor allows integrating a third party code within client 32. Trusted monitor 370 can measure the display of thin advertisements all interaction with thin advertisements. Independently measurement could be done by counting events or by any COTS decryption technology.

Client 32 can include advertisement fulfillment engine 310, but this is not necessarily so—and thin advertisement engine 310 can be separated from client 32. Hitherto, it is assumed that client 32 implements the ad fulfillment engine, and the terms are used interchangeably, but it is noted that the two may be separate modules.

Client 32 is conveniently responsible for downloading thin advertisements from the advertisement server 20, and process then so that a display will display the thin advertisements. According to an embodiment of the invention, client 32 is further configured to notify advertisement server 20 a thin advertisement was placed, and possibly also additional information about how the user interacted with it.

It is noted that client 32 (and/or the Ad Fulfillment Engine) may, according to an embodiment of the invention, be required for different types of middleware platform. For example, interactive applications for Amino may be developed using JavaScript while interactive applications for OpenTV may be developed using an SDK based on C language.

Conveniently, other client 36 should include some identification of the video asset in the notification. It is noted that, conveniently, each detail that is reported by the other client 36 saves processing time in the advertisement decider that is implemented by client 32, advertisement server 20 or both. Advertisement server 20 can obtain this information during the enrichment process.

After a notification is received from the other client 36, thin advertisement engine 310 can query advertisement server 20 for the next thin advertisements to be displayed. The thin advertisement engine 310 is usually configured to download a configurable number of thin advertisements each time and will repeat this process each time the number of remaining thin advertisements will reach some configurable threshold. It is noted that, according to an embodiment of the invention, thin advertisements (or, as aforementioned, other multimedia content) are stored locally on STB 30 (e.g. in a storage unit 38) until they are displayed, so that thin advertisement engine 310 will be able to display a thin advertisement as fast as possible after a thin advertisement event is triggered.

Thin advertisement engine 310 can carry out one or more of the following functionalities or assist in fulfilling the functionality: (i) manage placement requests—requesting one or more thin advertisements according to placement potential, (ii) participate in a display of a thin advertisement—displaying thin advertisements when triggered while remembering interactive operations; and (iii) manage placement notification—reporting thin advertisement display and interactivity at appropriate time.

According to several embodiments of the invention, a displaying of a thin advertisement may be triggered in one or more of the following events: (i) Some operation that the user initiated, such as pause or fast-forward—In this case one thin advertisement or more can be displayed immediately or at some interval after the operation was initiated. Also, these thin advertisements may be automatically replaced by different thin advertisements after some interval. Thin advertisements that are triggered by user initiated events must be destroyed immediately or some interval after the user initiated event is over (e.g. the user resumes the video asset after having paused it); (ii) Some position relative to the beginning or ending of the video asset was reached—In this case thin advertisements may pop-up spontaneously on the screen while the content is being watched. This requires the ability to query the NLTA client for the current viewing position of the video asset. If the NLTA client did not report the video asset length in the notification, then we will have to get this detail from the advertisement decider during the enrichment process.

According to an embodiment of the invention, each thin advertisement which is downloaded from the advertisement server 20 is associated with an “Ad Format” and “Ad Media” definitions. In general, the Ad Format includes details that are necessary for the thin advertisement engine 310 to decide which triggers to wait for and which thin advertisements to display in each trigger, while the Ad Media defines what the actual thin advertisement looks like, how it interacts with the user and what information it reports back to the advertisement decider.

It is noted that client 32 may be loaded to STB 30 in different methods according to different embodiments of the invention. Two such methods are, for example: (i) Software update—the network operator will deploy a software update for all the STBs in his network, configuring them to run client 32 (including Thin advertisement engine 310) to run alongside another client. (ii) Data Multiplexing—The network operator will multiplex client 32 into VOD and broadcast channels. For VOD channels, client 32 will be invoked, while for broadcast channels, client 32 will let itself be recorded by DVRs along with the video content and will be invoked by the PVR client once it starts to playback the recorded content.

It is noted that client 32 is conveniently configured to exchange information with other client 36. For example, Thin advertisement engine 32 communicates with other client 36 in one or more of the following scenarios:

i. Registering for notifications—Some mechanism will be available for the Thin advertisement engine 310 to register and un-register for notifications that are defined in the following scenarios.
ii. Receiving notifications when the user starts to watch some video asset—This notification should include as much information as possible about the video asset and must include at least identification for the video asset. Upon receiving this notification, the thin advertisement engine 310 should download the first batch of thin advertisements from the advertisement decider.
iii. Receiving periodic notifications about video asset progress—This notification is necessary for the thin advertisement engine 310 to display timed pop-up thin advertisements while the content is being watched. The frequency of the notification will be defined in the registration process.
Receiving notifications about user initiated events—This notification will be triggered when the user initiates some operation, such as pause or fast forward. In general, the thin advertisement engine 310 might be able to receive this kind of notification directly from the middleware, or from other client 36 so that it will be able to ask it to hide his on-screen controls so it can display a thin advertisement in their place.

It is noted that in different embodiments of the invention, different data types are implemented for client 32, and that usually, the Ad Fulfillment Engine's data types are defined by its interfaces. According to an embodiment of the invention, a campaign manager interface is used for Ad Media and Ad Format definitions, while the advertisement decider interface is used for placement request and notification messages and their counterpart response messages. According to an embodiment of the invention, the different data types of client 32 are represented in XML format. More specifically, according to an embodiment of the invention, advertisement placement XML formats are defined by the SCTE130 standard.

The Ad Media format is conveniently divided to Resources and Ad instances and has a Minimum Duration attribute which is useful when displaying multiple thin advertisements in the same user initiated event trigger.

Resources are actually URLs which are pointing to multimedia content such as banners and audio files that are used throughout the advertisement display. Each Resource has an identifier and possibly a language associated with it. The identifier is used each time the resource is referenced in the Ad Instance, while each identifier may be associated with multiple URLs with different languages. When an Ad Media is downloaded to the STB, the thin advertisement engine 310 immediately downloads the Resources content from the URLs that have the appropriate language associated with them.

Ad Instances conveniently describe how the multiple Resources are used in order to perform the advertisement display. They may include, for example, Constraints, Gadgets and Scripts. Constraints describe the languages and STB model that the Ad Instance is relevant for. An Ad Media may contain multiple Ad Instances, but the when the an advertisement is sent to the STB, the advertisement decider sends only the Ad Instance whose Constraints best describe the appropriate language and STB model. Gadgets describe the UI elements used in the advertisement and their initial attributes, while Scripts describe how they change over time during the advertisement display. Each Gadget in the Ad Instance is associated with an identifier, type and attributes. The attributes set associated with the Gadget is dependant entirely on the Gadget's type: [should I make the changes in sections 29, 30 here as well?]

i. Banner—This gadget type represents an image that appears on the screen. Its attributes are: X Location and Y Location which describe the initial coordinates for the banner, Width and Height which describe its initial size, Z-Order which defines which banner is top-most, Transparency Ratio which define alpha blending, Transparent Color which may define one invisible color and Resource which is an identifier referencing the Resource defined above.
ii. Audio—This gadget type represents a sound clip which can be played. Its attributes are: Volume which describes the initial decibel level, Loop which defines whether the sound clip is played repeatedly or only once and Resource which is an identifier referencing the Resource defined above.
iii. Shrinkage—This gadget type represents an area on the screen boundaries which remains blank instead of displaying video. Its attributes are: Top-Size, Left-Size, Right-Size and Bottom-Size which define the area used by the gadget in each screen boundary and Background-Color which is the color that appears on those boundaries instead of the video.
iv. Button—This gadget type represents how the thin advertisement should react to a certain button on the remote control. Its attributes are: Remote-Control-Button which is the button associated with the gadget, On-Click which is the script to be run when the button is pushed and Current-Script-Action which defines whether the current script should be aborted, suspended or continued.

According to an embodiment of the invention, each Script in the Ad Instance is associated with an identifier and a set of Action Groups. When the thin advertisement starts playing, the script identified as “Main” is ran, when the thin advertisement is gracefully removed, the script identified as “Esc” is ran and when a remote control button associated with a Button Gadget is pushed, the thin advertisement referenced by the On-Click attribute is ran.

Each Action Group may be associated with an identifier, timing attributes and actions:

i. The timing attributes define when the Action Group starts to run, how many times and in what interval it runs and which Action Groups should be executed after it finishes its run. Some Action Groups are configured to run a certain interval after their Script starts executing and some are configured to run a certain interval after another Action Group invokes them.
ii. The actions in each Action Group may disable or enable each Gadget and they may also modify each Gadget's attributes relatively or absolutely. For example, an action group may move a Banner Gadget one pixel to the bottom and right (relative) and it might changes its transparency ratio to 50% (absolute). An action may change any attribute in every Gadget. Even the Resource attribute can be modified to point on a different image in order to create a simple animation. Each Gadget is disabled by default and must be enabled when the advertisement intends to show it to the user and let the user interact with it.

It is noted that several multimedia content items may be displayed to the user at least partly concurrently. In an example, vertical and horizontal banners are sliding into the screen while it is being shrunk. The sliding effect includes sixteen frames and is ended after two seconds. The sliding banners suggest the user to push the green button in order to show more information on screen about some sale. If the user does not push the button after 10 seconds, the banners slide out the same way they came while reverting the shrink effect.

If the button is pushed, the screen is reverted to 100% and a banner appears on the screen center, exposing more information to the user. The banner suggests the user to push the red button in order to receive a brochure by mail while playing an audio file in a loop.

If the button is pushed, a smaller feedback banner appears on top of the previous banner while the audio keeps playing in a loop. Five seconds after the feedback banner appears, both banners will disappear and the audio clip will stop playing. If ESC is pushed at any stage during the ad, the screen is reverted to 100%, all the banners are removed and the audio stops.

Some examples for ways of displaying the multimedia content to the user are:

i. The video may be reduced to 75% of its real size and aligned to the bottom-right screen corner while a banner appears between the empty place which remains to left and to the top of the video. This kind of banner may appear during credits, fast-forwarding, rewinding or even for a few seconds while the content is being watched.
ii. When the user pauses the content he is watching, a large banner appears in the center of the screen. The banner tells the user to press the red button on his remote control if he wants to receive more information about the product by mail. The mail address of users who requested to receive information by mail is reported by the campaign manager to the advertiser on a daily, weekly or monthly basis.
iii. While content is being watched a small text banner with transparent background appears in the top left corner asking the user to press the red button if he wants to make a food order. When he pushes the red button, the content is automatically paused and the user can fill-in the order details. The address of the user and the order details are sent by the campaign manager to the advertiser immediately.
iv. When the user adjusts the volume or requests content information, a branded control appears instead of the standard control.

Referring again to either one of FIGS. 1 and 2, STB 30 is connected to OOB channel and to an in band channel that can include a multicasting channel and a broadcasting channel. OOB channel can be used for exchanging information with client 32 while the in band channel can be used for providing non linear video content (such as VOD) that is broadcasted/multicasted to STB 30. VOD video assets can be generated by VDO server 50 and transmitted after being modulated by operator's multiplexers/modulators 40.

When the user is initiating a non linear video application (NLTA) on his STB 30, client 32 is configured to establish a communication channel with advertisement server 20. The advertisement server 20 may identify the TV subscriber by querying a subscriber management system 10 and starts transmitting relevant thin advertisements to STB 30 using the OOB channel 32. The retrieved thin advertisements are stored at storage unit 38.

Client application 32 can conveniently receive notifications from advertisement server 20 during the non linear video application (for example in the discovery mode and during the video session itself and immediately following the video before returning to live viewing). The notifications can include unique parameters that characterize the thin advertisement.

A thin advertisement can include Text; Audio; Still picture; Animation. Thicker advertisements that can be managed by more advanced set top boxes can. Other parameters which may be defined in association with a thin advertisement can include an expiration timer (how long the thin advertisement will appear or will be stored at STB 30), Link/pointer to the specific content on STB storage unit, animation structure (defines how the animation should operate) Color scheme Others, etc.

According to an embodiment of the invention, client 32 receives different advertisement content from the advertisement server 20 through OOB channel during the whole non linear video session (NLTA) and to store in STB 30. Once a notification is received, client 32 responds immediately and presents the thin advertisement. It is noted that, according to an embodiment of the invention, the multimedia content to be displayed as a thin advertisement is received only adjacently to the displaying.

Client 32 can receive trigger events from the TV subscribers. These trigger events are trick-play events such as: Pause, Rewind (all speeds), Fast forward (all speeds), Volume Up/Down, Brightness Up/Down, End of VOD/PVR session Others

Once an event is captured client 32 sends a trigger event notification to the advertisement server 20 which in return sends a respond to trigger event notification message to client 32. This notification is basically the same as the thin advertisement notification and includes similar parameters.

Client 32 is configured, according to an embodiment of the invention, to parse the notification message and to execute the relevant commands in order to present the TV subscriber with the relevant advertisement or promotion.

Client 32 can receive a response from the TV subscribers to specific advertisement or promotion and send it to advertisement server 20 for further processing: abort thin advertisement, request for information or execute an interactive session related to the thin advertisement.

For the support of video content advertisement server 20 is able, according to an embodiment of the invention, to communicate with the VOD server 50 once there's a need to play a pre-post-mid advertisement or promotion. The advertisement server 20 triggers the VOD servers 50 to play the right advertisement/promotions at the exact time stamp.

The client 32 also aggregates, according to an embodiment of the invention, specific events which were triggered by the TV subscriber with the appropriate time stamps. These events are sent to the advertisement server 20 for further processing i.e. reporting, statistics, personalization, etc.

The above described scenario can be extended to the use to the interactive carousel 60 in cases of narrow band return channel for example due to lack bandwidth allocation. The advertisement server 20 will be able to determine in real-time and based on efficiency considerations what is the best route to deliver the content to the STB 30. In this scenario the notifications from the advertisement server 20 to the client application which reside on the STB 30 and the notifications from the client 32 to the advertisement server 20 due to user trigger events remain the same. The only change in the flow is that thin advertisement is being broadcasted to the STB 30 through the use of the interactive carousel 60 instead of using the existing narrow band return channel.

It is noted that different features of the disclosed system 100 and STB 30 according to several embodiments of the invention are: (i) Client 32 which may be, according to an embodiment of the invention, indifferent to the middleware and set-top box that uses the return channel in order to provide advertisement or promotions during non linear video applications NLTA; (ii) No need to add/modify existing hardware/software in the head-end and in the set-top boxes; (iii) Unicast solution for advertisement & promotions which enables targeting of individual set-top boxes; (iv) Minimizing the latency time needed for presenting advertisement or promotion. Downloading advertisement/promotion media using the existing interactive carousel exposes the user to major latency problems; (v) Trick play handling through the return channel and supports trick play advertisement/promotions i.e. pause, forward, rewind, etc; (vi) Supports and provides interactivity to the presented advertisement/promotions; (vii) Inexpensive solution in comparison to the existing ad-insertion solutions; (viii) enables segmentation and personalization of advertisement/promotions due to the unique identification of the user set-top box; (ix) Supports and handles a wide range of multimedia content i.e. video, text, audio, still picture and animation; (x) Presenting advertisements throughout the non linear video session and not in restricted areas alone.

According to an embodiment of the invention, thin advertisements are represented as Adobe Flash applications. The Thin advertisement engine 310 is conveniently able to interpret the application and execute it on the set-top-box with the limitations of using its native graphic API's.

According to an embodiment of the invention, in order to understand what media asset the user is currently watching, intercept pause, fast-forward and rewind events, and display our advanced ads, thin advertisement engine 310 can implement one or more low level hooks in middleware 300 so that code changes in the other client 36 will not be required. These hooks allow thin advertisement engine 310 to become a filter layer between the other client 36 and middleware 300. This way, any information passed through the other client 36 and middleware 300 passes through thin advertisement engine 310 and can be edited by it before the information reaches its destination.

According to an embodiment of the invention client 32, thin advertisement engine 310 or a combination thereof can be executed by devices such as mobile phones, media players, computers and the like.

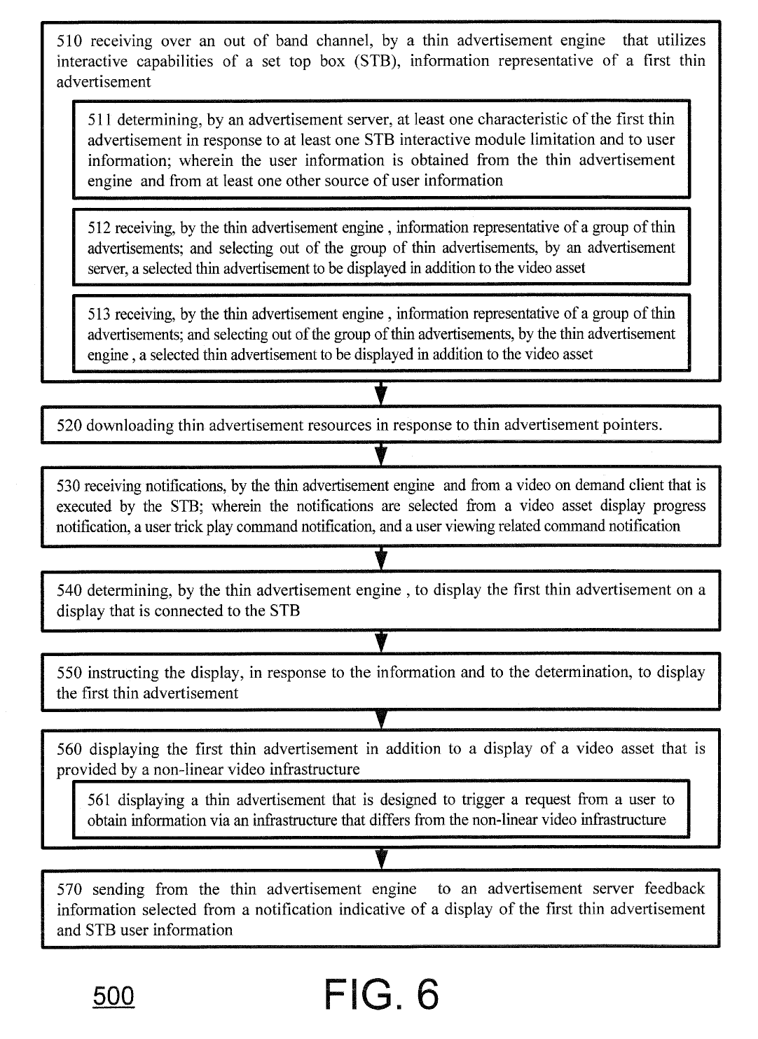

FIG. 6 illustrates method 500 for displaying advertisement to a user, according to an embodiment of the invention. It is noted that method 500 may be carried out in a system such as system 100, and especially by STB 30. Furthermore, it is noted that different embodiments of STB 30 are usually configured to implement different embodiments of method 500 and other components of system 100 may be adapted to participate in system 100, even if not so explicitly elaborated.

Method 500 conveniently starts with receiving, by an advertisement fulfillment engine that utilizes interactive capabilities of a STB, over an out of band channel, information representative of a first thin advertisement.

According to an embodiment of the invention, method 500 further includes stage 511 of determining, by an advertisement server, at least one characteristic of the first thin advertisement in response to at least one user device (such as STB) interactive module limitation and to user information; wherein the user information is obtained from the advertisement fulfillment engine and from at least one other source of user information.

According to an embodiment of the invention, method 500 further includes stage 512 of receiving, by the advertisement fulfillment engine, information representative of a group of thin advertisements; and selecting out of the group of thin advertisements, by an advertisement server, a selected thin advertisement to be displayed in addition to the video asset.

According to an embodiment of the invention, method 500 further includes stage 513 of receiving, by the advertisement fulfillment engine, information representative of a group of thin advertisements; and selecting out of the group of thin advertisements, by the advertisement fulfillment engine, a selected thin advertisement to be displayed in addition to the video asset.

Referring to stage 510, it is noted that according to an embodiment of the invention, the information includes thin advertisement pointers that point to location of thin advertisement resources. According to such an embodiment of the invention the receiving of the information is followed by stage 520 of downloading thin advertisement resources in response to the thin advertisement pointers.

According to an embodiment of the invention, method 500 further includes stage 530 of receiving notifications, by the advertisement fulfillment engine and from a video on demand client that is executed by the STB; wherein the notifications are selected from a video asset display progress notification, a user trick play command notification, and a user viewing related command notification.

Method 500 continues with stage 540 of determining, by the advertisement fulfillment engine, to display the first thin advertisement on a display that is connected to the STB. According to an embodiment of the invention, the determining is responsive to at least one of: i a trick play command received by the STB; and ii at least one predetermined offset defined from at least one point in time associated with a progress of a display of the video asset.

Method 500 conveniently continues with stage 550 of instructing the display, in response to the information and to the determination, to display the first thin advertisement, which is followed by stage 560 of displaying the first thin advertisement in addition to a display of a video asset that is provided by a non-linear video infrastructure.

According to an embodiment of the invention, method 500 includes stage 561 of displaying a thin advertisement that is designed to trigger a request from a user to obtain information via an infrastructure that differs from the non-linear video infrastructure.

It is noted that, according to an embodiment of the invention, the non-linear video infrastructure is a video on demand infrastructure.

According to an embodiment of the invention, method 500 further includes stage 570 of sending from the advertisement fulfillment engine to an advertisement server feedback information selected from a notification indicative of a display of the first thin advertisement and STB user information.

Generally, it is noted that according to an embodiment of the invention, the thin advertisement is selected from graphics overlaid on the video asset, graphics displayed at a display region that differs from a display region on which the video asset is displayed.

According to an embodiment of the invention, the advertisement fulfillment engine is executed by an interactive module of the set top box.

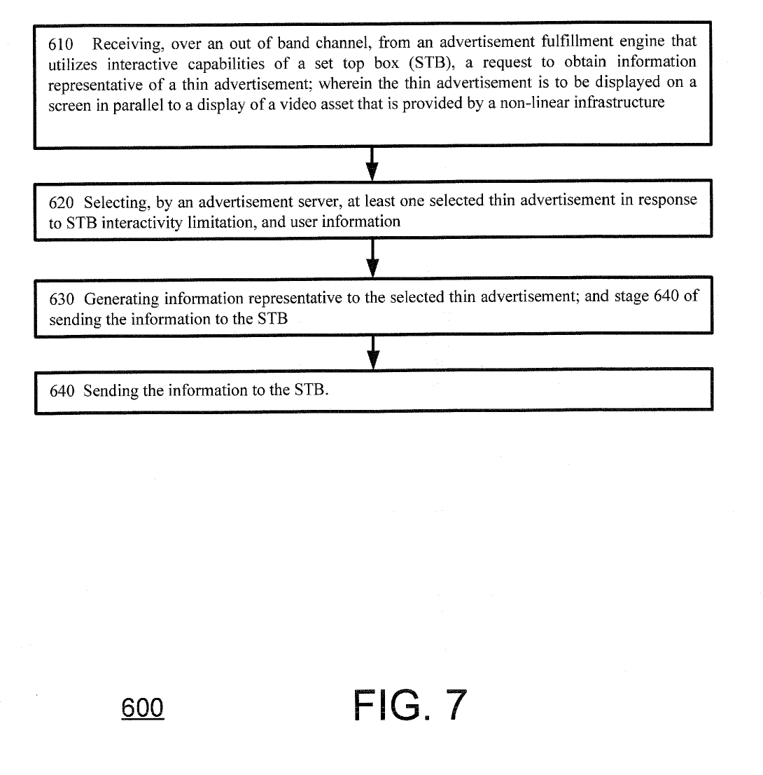

FIG. 7 illustrates method 600 for displaying advertisement to a user, according to an embodiment of the invention. method 600 includes stage 610 of receiving, over an out of band channel from an advertisement fulfillment engine that utilizes interactive capabilities of a set top box STB, a request to obtain information representative of a thin advertisement; wherein the thin advertisement is to be displayed on a screen in parallel to a display of a video asset that is provided by a non-linear infrastructure; stage 620 of selecting, by an advertisement server, at least one selected thin advertisement in response to STB interactivity limitation, and user information; stage 630 of generating information representative to the selected thin advertisement; and stage 640 of sending the information to the STB.

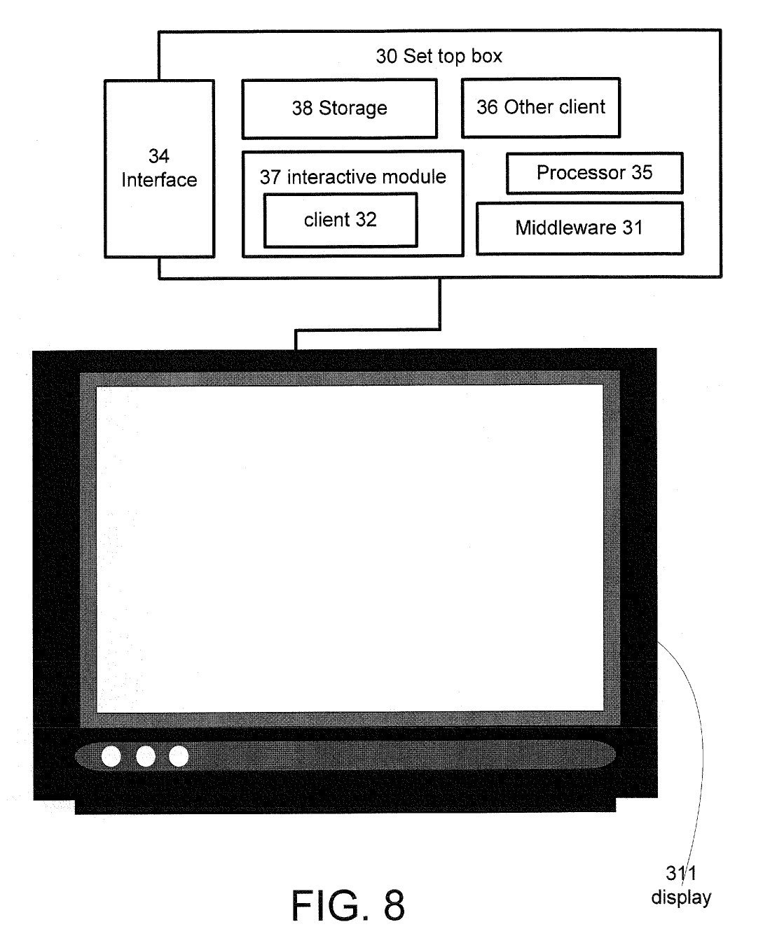

FIG. 8 illustrates system 300, according to an embodiment of the invention. System 300 may and may not be a part of system 100. System 300 includes a user device such as STB 30 and a display 311. STB 30 can be STB of either one of FIGS. 1, 2, 3 and 4. Display 311 receives instructions to display the first thin advertisement in addition to a display of a video asset that is provided by a non-linear video infrastructure. It is noted that the tuner can be a part of the television.

According to an aspect of the invention, a computer program product is disclosed, which includes a computer readable medium that stores instructions that when executed by an interactive module of a set top box causes the interactive module to: a receive, by an advertisement fulfillment engine that is executed by the interactive module, information representative of a first thin advertisement; b determine, by the advertisement fulfillment engine, to display the first thin advertisement on a display that is coupled to the STB; and c instruct the display, in response to the information and to the determination, to display the first thin advertisement; wherein the first thin advertisement is displayed on the display in addition to a display of a video asset that is provided by a non-linear video infrastructure.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for displaying advertisement to a user, the method comprises:
receiving, over an out of band channel and by an advertisement fulfillment engine that utilizes interactive capabilities of a user device, information representative of a first thin advertisement;
determining, by the advertisement fulfillment engine, to display the first thin advertisement on a display that is coupled to the user device;
instructing the display, in response to the information and to the determination, to display the first thin advertisement; and
displaying the first thin advertisement in addition to a display of a video asset that is provided by a non-linear video infrastructure.

2. The method according to claim 1 wherein the user device is a mobile phone.

3. The method according to claim 1 wherein the user device is a media player.

4. The method according to claim 1 wherein the non-linear video infrastructure is a video on demand infrastructure.

5. The method according to claim 1 wherein the out of band channel is a dial up channel.

6. The method according to claim 1 wherein the user device is a set top box (STB).

7. The method according to claim 6 wherein the determining is responsive to at least one of: (i) a trick play command received by the STB; and (ii) at least one predetermined offset defined from at least one point in time associated with a progress of a display of the video asset.

8. The method according to claim 6 comprising sending, from the advertisement fulfillment engine to an advertisement server, feedback information selected from a notification indicative of a display of the first thin advertisement and STB user information.

9. The method according to claim 6 wherein the thin advertisement is selected from graphics overlaid on the video asset, graphics displayed at a display region that differs from a display region on which the video asset is displayed.

10. The method according to claim 6 wherein the information comprises thin advertisement pointers that point to location of thin advertisement resources and wherein the receiving of the information is followed by downloading thin advertisement resources in response to the thin advertisement pointers.

11. The method according to claim 6 comprising receiving, by the advertisement fulfillment engine, information representative of a group of thin advertisements; and selecting out of the group of thin advertisements, by an advertisement server, a selected thin advertisement to be displayed in addition to the video asset.

12. The method according to claim 6 comprising receiving, by the advertisement fulfillment engine, information representative of a group of thin advertisements; and selecting out of the group of thin advertisements, by the advertisement fulfillment engine, a selected thin advertisement to be displayed in addition to the video asset.

13. The method according to claim 6 comprising determining, by an advertisement server, at least one characteristic of the first thin advertisement in response to at least one STB interactive module limitation and to user information; wherein the user information is obtained from the advertisement fulfillment engine and from at least one other source of user information.

14. The method according to claim 6 comprising receiving notifications, by the advertisement fulfillment engine and from a video on demand client that is executed by the STB; wherein the notifications are selected from a video asset display progress notification, a user trick play command notification, and a user viewing related command notification.

15. The method according to claim 6 wherein the advertisement fulfillment engine is executed by an interactive module of the set top box.

16. The method according to claim 6 comprising displaying a thin advertisement that is designed to trigger a request from a user to obtain information via an infrastructure that differs from the non-linear video infrastructure.

17. The method according to claim 6 comprising monitoring a display of thin advertisement by a trusted monitor.

18. The method according to claim 6 comprising monitoring a response to a display of thin advertisement by a trusted monitor code.

19. The method according to claim 6 comprising downloading multiple thin advertisements to the STB.

20. A method for displaying advertisement to a user, the method comprises:
receiving over an out of band channel and from a an advertisement fulfillment engine that utilizes interactive capabilities of a user device, a request to obtain information representative of a thin advertisement; wherein the thin advertisement is to be displayed on a screen in parallel to a display of a video asset that is provided by a non-linear infrastructure;
selecting, by an advertisement server, at least one selected thin advertisement in response to user device interactivity limitation, and user information;
generating information representative to the selected thin advertisement; and
sending the information to the user device.

21. The method according to claim 20 wherein the user device is a set top box.

22. A user device comprising at least one interface and an interactive module;
wherein the interactive module supports an advertisement fulfillment engine that determines to display a first thin advertisement on a display; and
wherein the at least one interface receives over an out of band channel information representative of a first thin advertisement;
wherein the display receives instructions to display the first thin advertisement in addition to a display of a video asset that is provided by a non-linear video infrastructure.

23. A computer program product that comprises a computer readable medium that stores instructions that when executed by an interactive module of a user device causes the interactive module to:
receive over an out of band channel, by an advertisement fulfillment engine that is executed by the interactive module, information representative of a first thin advertisement;
determine, by the advertisement fulfillment engine, to display the first thin advertisement on a display; and
instruct the display, in response to the information and to the determination, to display the first thin advertisement; wherein the first thin advertisement is displayed on the display in addition to a display of a video asset that is provided by a non-linear video infrastructure.
